(19) United States
(12) Patent Application Publication
(10) Pub. No.: US 2009/0162922 A1
(43) Pub. Date: Jun. 25, 2009

(54) DIESEL EXHAUST GAS SCRUBBING METHOD FOR CARBON DIOXIDE REMOVAL

(75) Inventors: Jim De Mattia, Brawley, CA (US); Dallas Weaver, Huntington Beach, CA (US)

Correspondence Address: KNOBBE MARTENS OLSON & BEAR LLP, 2040 MAIN STREET, FOURTEENTH FLOOR, IRVINE, CA, 92614, US

(73) Assignee: Carbon Capture Corporation, La Jolla, CA (US)

(21) Appl. No.: 12/338,982

(22) Filed: Dec. 18, 2008

Related U.S. Application Data
(60) Provisional application No. 61/015,141, filed on Dec. 19, 2007.

(51) Int. Cl. B01D 53/84; B01D 53/92

(52) U.S. Cl. 435/266; 422/168

(57) ABSTRACT

Systems and methods for removing carbon dioxide from gas, e.g., diesel exhaust gas, are provided. The systems involve uptake of carbon dioxide by algae in water to which the gas is exposed.

### CROSS-REFERENCE TO RELATED APPLICATIONS

This application claims the benefit of U.S. Provisional Application No. 61/015,141 filed Dec. 19, 2007. The contents of the aforementioned application are incorporated by reference herein in their entirety, and are hereby made a part of this specification.

### FIELD OF THE INVENTION

Systems and methods for removing carbon dioxide from gas, e.g., diesel exhaust gas, are provided. The systems involve uptake of carbon dioxide by algae in water to which the gas is exposed.

### BACKGROUND OF THE INVENTION

Carbon dioxide (CO₂) is the most important greenhouse gas produced by human activities, primarily through the combustion of fossil fuels. Its concentration in the Earth's atmosphere has risen by more than 30% since the Industrial Revolution. Atmospheric mixing ratios for carbon dioxide are now higher than at any time in the last 800,000 years, standing at 380 parts per million (ppm) compared to a pre-industrial high of 280 ppm. The current rate of increase is about 2 ppm per year.

Sources of carbon dioxide include respiration, vulcanism, and changes in land use. However, of the carbon dioxide emissions arising from fossil fuel combustion, about 40% is a result of electricity generation, with coal-fired generation being the leading sector. Other stationary sources include industrial sources (e.g., iron and steel manufacture), boilers, emissions resulting from oil extraction, refining, and transportation, and domestic and commercial fossil fuel use.

Carbon dioxide is also produced in lime and cement manufacture as a result of the heating of limestone, with the amount of CO₂ produced varying depending upon the type of cement being made. Globally, this particular source is estimated to amount to 0.2 Pg C (petagrams of Carbon) of emissions to the atmosphere each year. Significant carbon dioxide emissions (about 0.25 Pg C per year) also result from its use in chemical feedstocks.

Stationary diesel engines are a significant source of carbon dioxide emissions. On Jun. 30, 2005, new rules were proposed by the Environmental Protection Agency (EPA) to limit air pollution emitted by stationary diesel engines. The proposal marks the first time that stationary diesel engines, found in power plants and factories, will be subject to EPA air quality regulations. However, the regulations will only apply to engines manufactured or reconstructed after April 2006, when the rule becomes effective. The rules will not affect an estimated 600,000 operating stationary diesel engines. EPA expects that by 2015 the 68,000 tons of pollutants currently in the atmosphere will be annually reduced due to the new regulation. The pollutants mentioned in the proposed rules include nitrogen oxides, sulfur dioxide, carbon monoxide, hydrocarbons and particulate matter. The EPA has scheduled the regulations to be phased in over the next ten years and will submit the final draft of the proposal within a year, allowing time for the public to comment on the rules.

### SUMMARY OF THE INVENTION

Methods and devices for use in reducing carbon dioxide from emissions from stationary sources are desirable in order to minimize the environmental impact of operation of these sources, and may be important in meeting any new rules imposed to limit carbon dioxide emitted by stationary sources, such as stationary diesel engines. The methods and devices of preferred embodiments are effective in reducing the carbon dioxide content of gases, and as such, can be effective in achieving the desired goals of minimizing environmental impact from carbon dioxide emissions and helping to achieve compliance with environmental regulations.

In a first aspect, a method for removing carbon dioxide from a gas is provided, the method comprising: providing a reservoir equipped with at least one paddle wheel, the reservoir containing water containing algae indigenous to the Imperial Valley of California; introducing a gas containing about 15% by volume or less of carbon dioxide into the water, whereby at least a portion of the carbon dioxide is solubilized in the water through the action of the paddle wheel, and wherein the solubilized carbon dioxide is metabolized by the algae; and removing a treated gas from the reservoir, wherein a concentration of carbon dioxide in the treated gas is less than 500 ppm.

In an embodiment of the first aspect, the reservoir is selected from the group consisting of a tank, a pool, a pond, and a manmade lake.

In an embodiment of the first aspect, the algae is Spirulina.

In an embodiment of the first aspect, the treated gas is introduced into an additional reservoir for removing additional carbon dioxide from the treated gas.

In an embodiment of the first aspect, algae respiration increases a pH of the water to a value of about 9 or greater.

In an embodiment of the first aspect, algae respiration increases the pH of the body of water to a value from about 9 to about 9.5.

In an embodiment of the first aspect, the gas containing about 15% by volume or less of carbon dioxide is exhaust gas from an engine that burns hydrocarbon fuel, e.g., a diesel engine.

In an embodiment of the first aspect, the method further comprises a step of processing the algae after it has metabolized the carbon dioxide from the gas to obtain at least one of an oil and a lipid for use in the production of biodiesel.

In an embodiment of the first aspect, the method further comprises a step of irrigating a crop with the water containing the algae after it has metabolized the carbon dioxide from the gas.

In an embodiment of the first aspect, the water is at a temperature of approximately 20° C.

In a second aspect, a mass transfer device for removing carbon dioxide from a gas is provided, the device comprising: a reservoir configured to contain water containing an algae indigenous to the Imperial Valley of California, wherein the algae metabolizes carbon dioxide; a first inlet configured to introduce water into the reservoir; a second inlet configured to introduce a gas containing about 15% by volume or less carbon dioxide into the reservoir; at least one agitating device situated within the reservoir and configured to agitate the carbon-dioxide absorbing liquid, wherein the agitating device is a paddle wheel; a motor configured to provide power to the agitating device; an outlet configured to release treated gas from the reservoir; and an outlet for water containing a suspension of algae having metabolized carbon dioxide.

### BRIEF DESCRIPTION OF THE DRAWINGS

FIG. 1 depicts a column of a preferred embodiment for removing carbon dioxide from an exhaust gas.

FIGS. 2a and 2b depict a column for removal of carbon dioxide from a stationary diesel engine.

FIG. 3 depicts a column of a preferred embodiment suitable for immersion in a body of water.

FIG. 4 depicts a first mass transfer device of a preferred embodiment for removal of carbon dioxide from an exhaust gas.

FIG. 5 depicts a second mass transfer device of a preferred embodiment for removal of carbon dioxide from an exhaust gas.

FIG. 6 depicts a third mass transfer device of a preferred embodiment for removal of carbon dioxide from an exhaust gas during operation.

FIG. 7 depicts an outside view of a mass transfer device of a preferred embodiment for removal of carbon dioxide from an exhaust gas.

FIG. 8 depicts inlet and outlet ports on a mass transfer device of a preferred embodiment for removal of carbon dioxide from an exhaust gas.

### DETAILED DESCRIPTION OF THE PREFERRED EMBODIMENT

The following description and examples illustrate a preferred embodiment of the present invention in detail. Those of skill in the art will recognize that there are numerous variations and modifications of this invention that are encompassed by its scope. Accordingly, the description of a preferred embodiment should not be deemed to limit the scope of the present invention.

Devices are provided for removing carbon dioxide from a gas by passing the gas through water containing an aqueous suspension of algae. In an alternative embodiment, devices are provided for removing carbon dioxide from a gas by dissolving CO₂ from the gas in water and subsequently contacting the water with suspension of algae to facilitate the uptake of the CO₂ by the algae. Gases suitable for treating using the devices of preferred embodiments typically have a relatively low concentration of carbon dioxide, e.g., about 25% by volume or less, preferably about 15% by volume or less. However, gases containing higher carbon dioxide concentrations can also advantageously be treated. Examples of gases suitable for treating using the systems and methods of the preferred embodiments include diesel exhaust, gasoline exhaust, gases generated or released in industrial processes, and various gases generated by respiration of living organisms or combustion of carbonaceous materials (biomass, waste, and the like). Because algae, a living organism, are employed, the gas treated is desirably minimally toxic to algae. However, in certain embodiments, as described below, gases that exhibit toxicity to algae can effectively be treated as well. Algae consume CO₂ in photosynthesis, which increases the pH of the water as carbonic acid (i.e., CO₂) is removed. Also, algae can combine bicarbonates (HCO₃⁻) to form CO₂ for photosynthesis, and carbonate (CO₃⁻²) is released, which combines with water to yield hydroxyl ions (a strong base). The release of carbonate converted from bicarbonate by algae causes pH to rise above 9 during periods of rapid photosynthesis. Carbon dioxide, like other gases, is soluble in water and can react with water to form a balance of several ionic and non-ionic species (collectively known as dissolved inorganic carbon). These include dissolved free carbon dioxide (CO_{2 (aq)}), carbonic acid (H₂CO₃), bicarbonate (HCO₃⁻) and carbonate (CO₃²⁻), and they interact with according to the following reaction

CO_{2 (aq)}+H₂O [symbol] H₂CO₃ [symbol] HCO₃⁻+H⁺ [symbol] CO₃²⁻+2H⁺

The balance of these carbonate species, which affects the solubility of carbon dioxide, is dependent to a large extent on pH. A higher pH environment shifts the equilibrium of the reaction to the right, reducing the concentration of the free carbon dioxide and carbonic acid species, which in turn leads to uptake of carbon dioxide from the gas passing through the column.

### Column Configuration

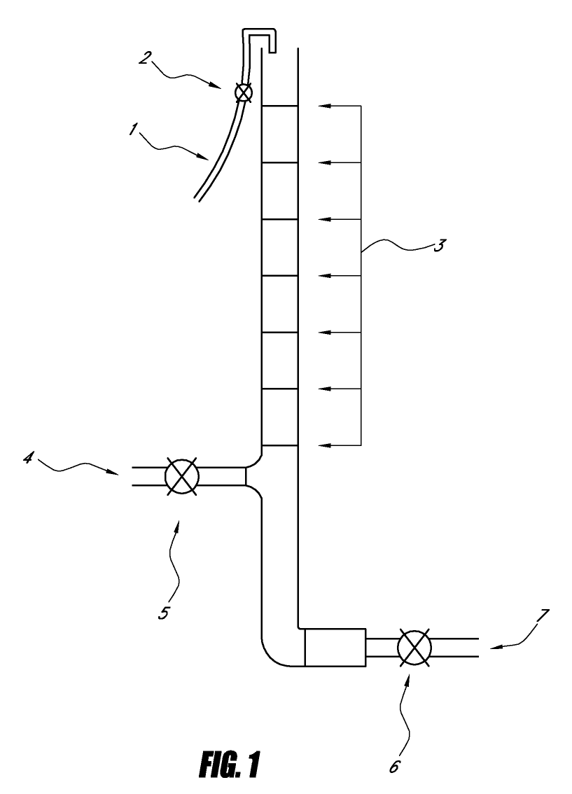

In preferred embodiments, as depicted in FIG. 1, a column is employed for purification. In some embodiments, water containing algae is introduced into the column, preferably at the top of the column so as to provide counter-current flow when exhaust gas is introduced into the column below the water inlet. Water containing algae that has taken up carbon dioxide from the exhaust gas stream is discharged from the column at the bottom. Desirably, the exhaust gas is exposed to increasingly fresh water as the gas rises to the top of the column; however, other configurations can also be employed. The water at the top of the column, having a higher pH, has greater effectiveness at capturing CO₂, which becomes less concentrated in the gas to be treated as it rises through the column.

In the preferred embodiment depicted in FIG. 1, water enters the column through inlet 1 after passing through valve 2; exhaust gas containing carbon dioxide enters through inlet 4 after passing valve 5. The exhaust gas passes through screens 3 placed about 1.2″ apart to reduce the size of exhaust bubbles. As the water captures carbon dioxide during its flow through the column, it exits the column through outlet 7 after passing valve 6.

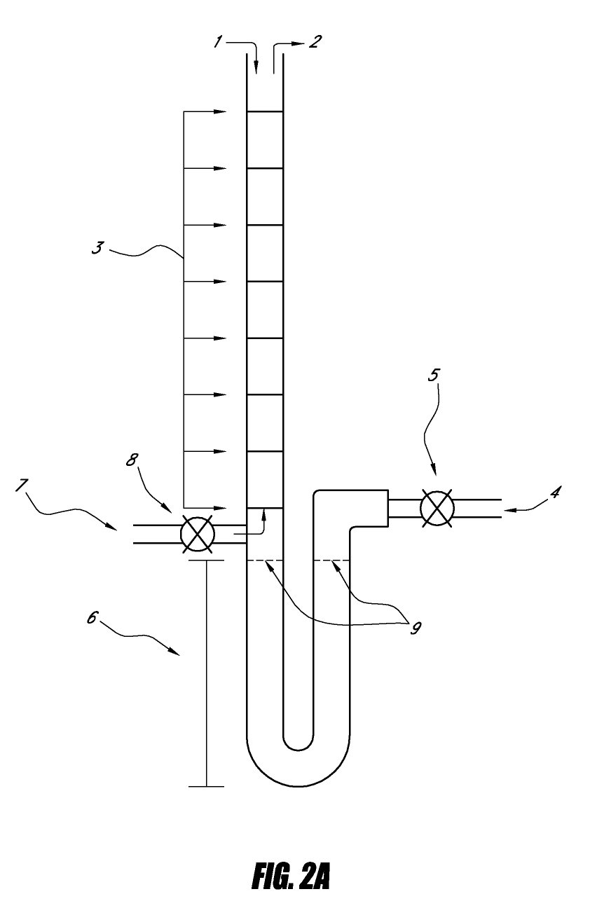

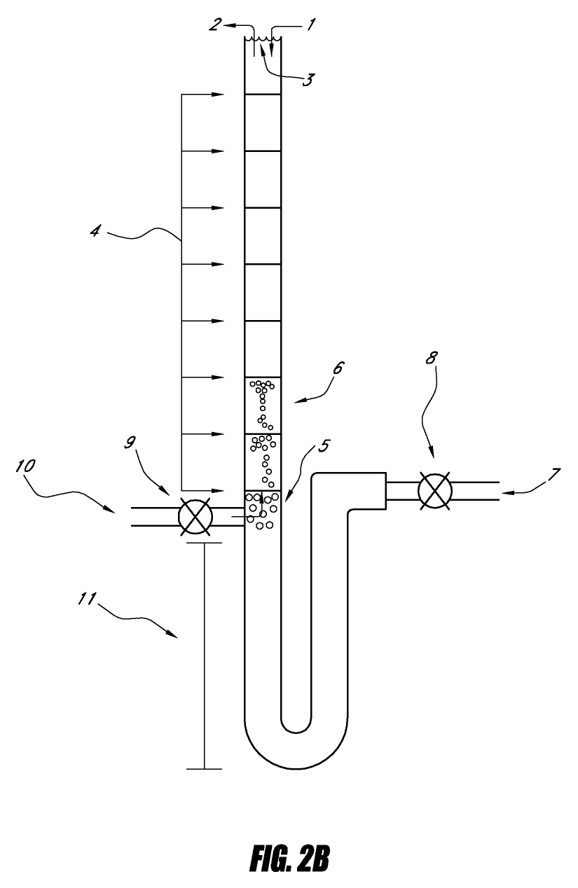

In another preferred embodiment of a column for the removal of carbon dioxide from a stationary engine, depicted in FIG. 2a, water enters the column through the top of the column 1; exhaust gas containing carbon dioxide enters through inlet 7 after passing valve 8. A water trap 6 inhibits exhaust gas from going down the column and maintains the water level 9. The exhaust gas passes through variably spaced screens 3 to reduce the size of exhaust bubbles. As the water captures carbon dioxide during its flow through the column, it exits the column through outlet 4 after passing valve 5. The purified exhaust gas exits the column through the top of the column 2.

In still another embodiment of a column for the removal of carbon dioxide from a stationary engine, depicted in FIG. 2b, water enters the column through the top of the column 1; exhaust gas containing carbon dioxide enters through inlet 10 after passing valve 9. A water trap 11 inhibits exhaust gas from going down the column and adjusts the flow of water through the column. The exhaust gas passes through variably spaced screens 4 to reduce the size of exhaust bubbles as seen in progressively smaller bubbles at 5 and 6. As the water captures carbon dioxide during its flow through the column, it exits the column through outlet 7 after passing valve 8. The purified exhaust gas exits the column through the top of the column 2.

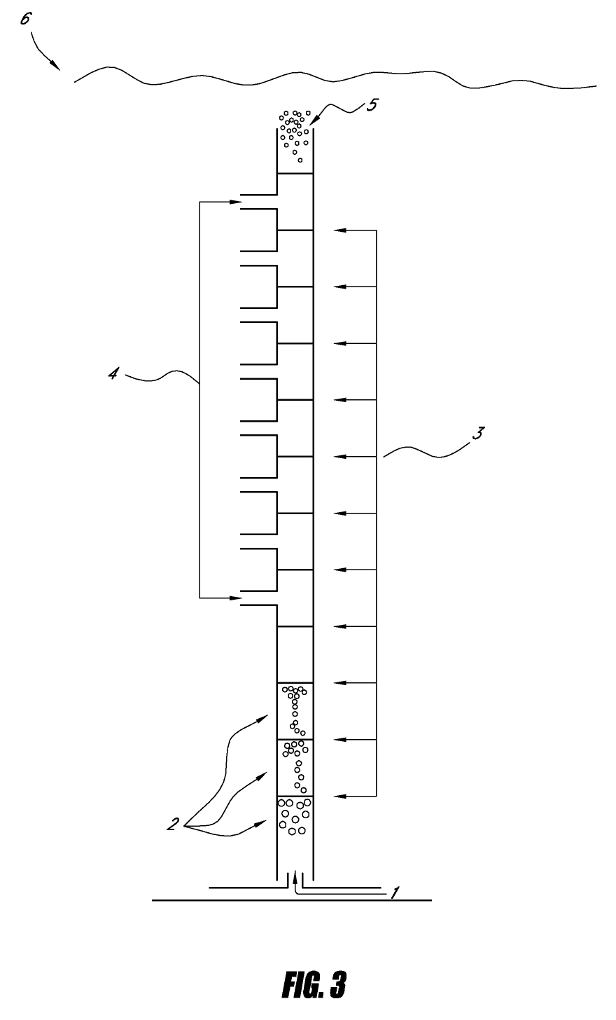

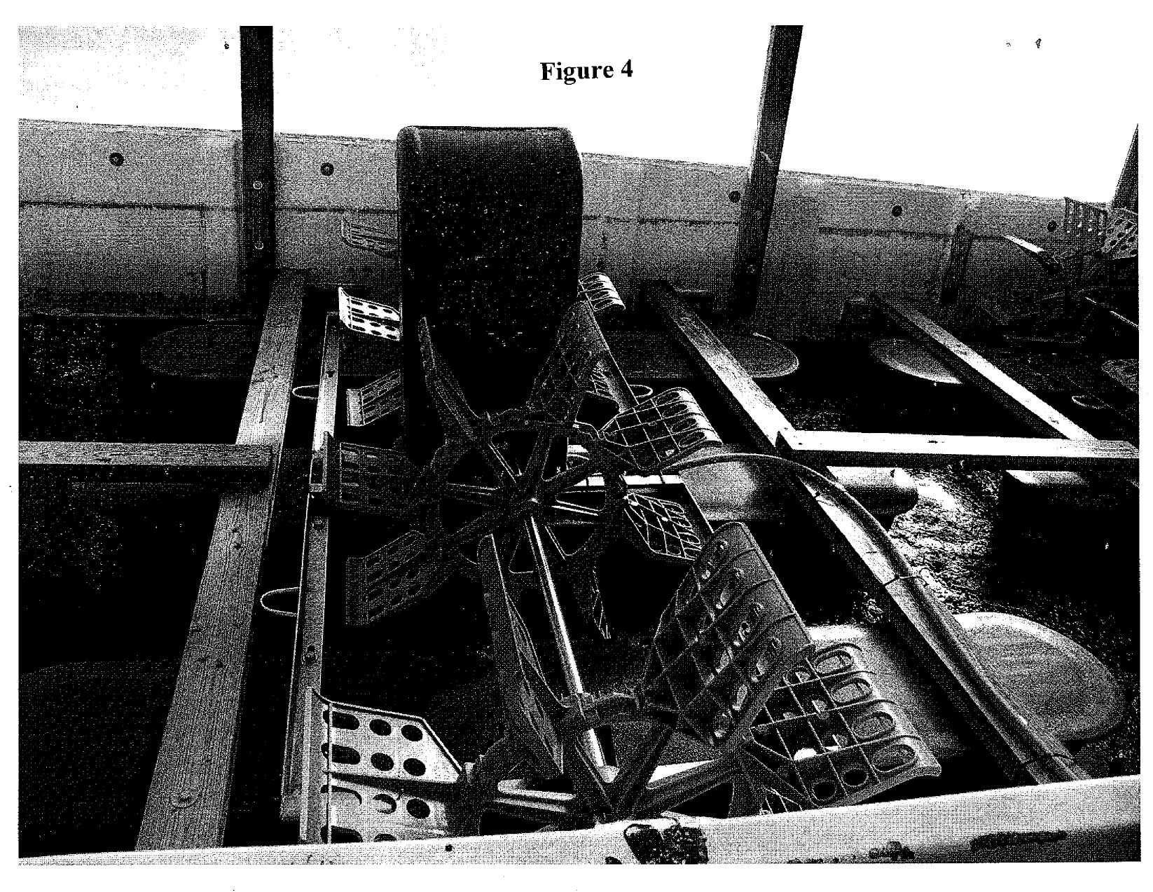

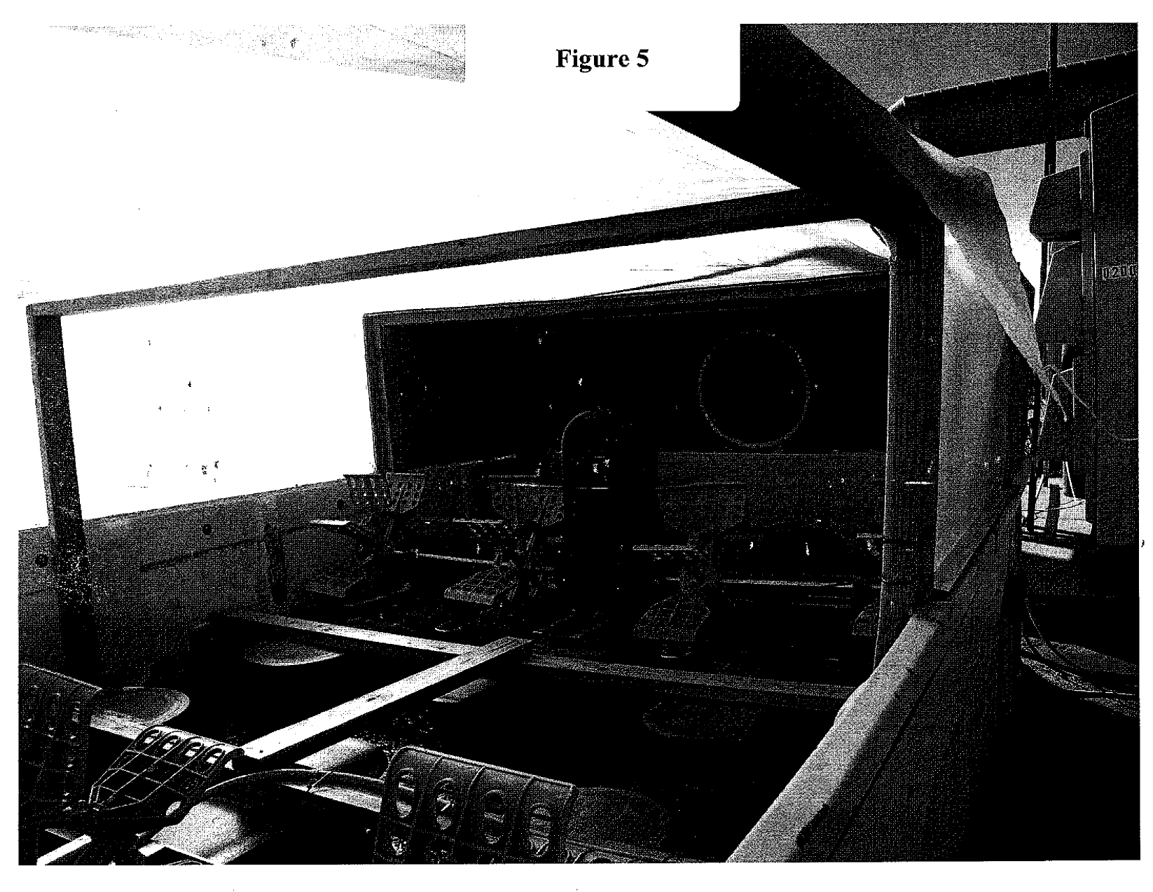

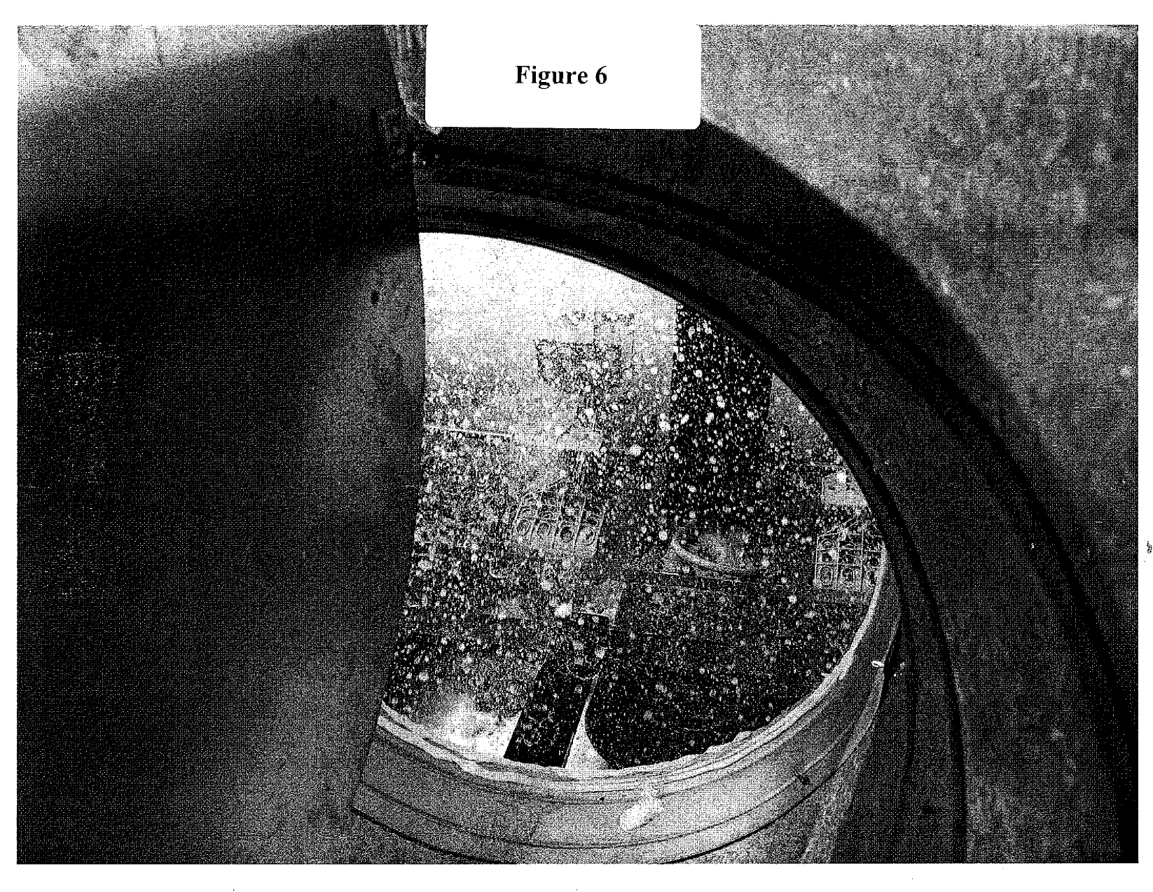

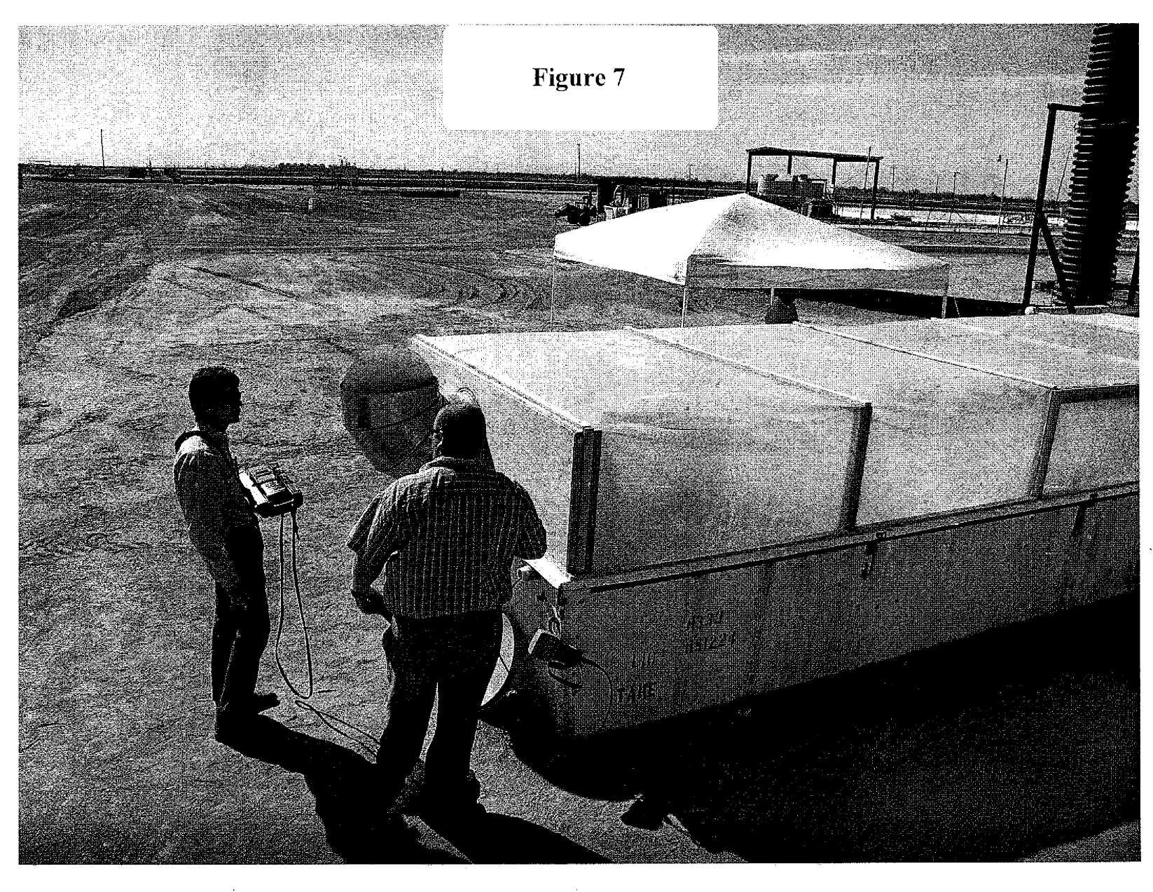

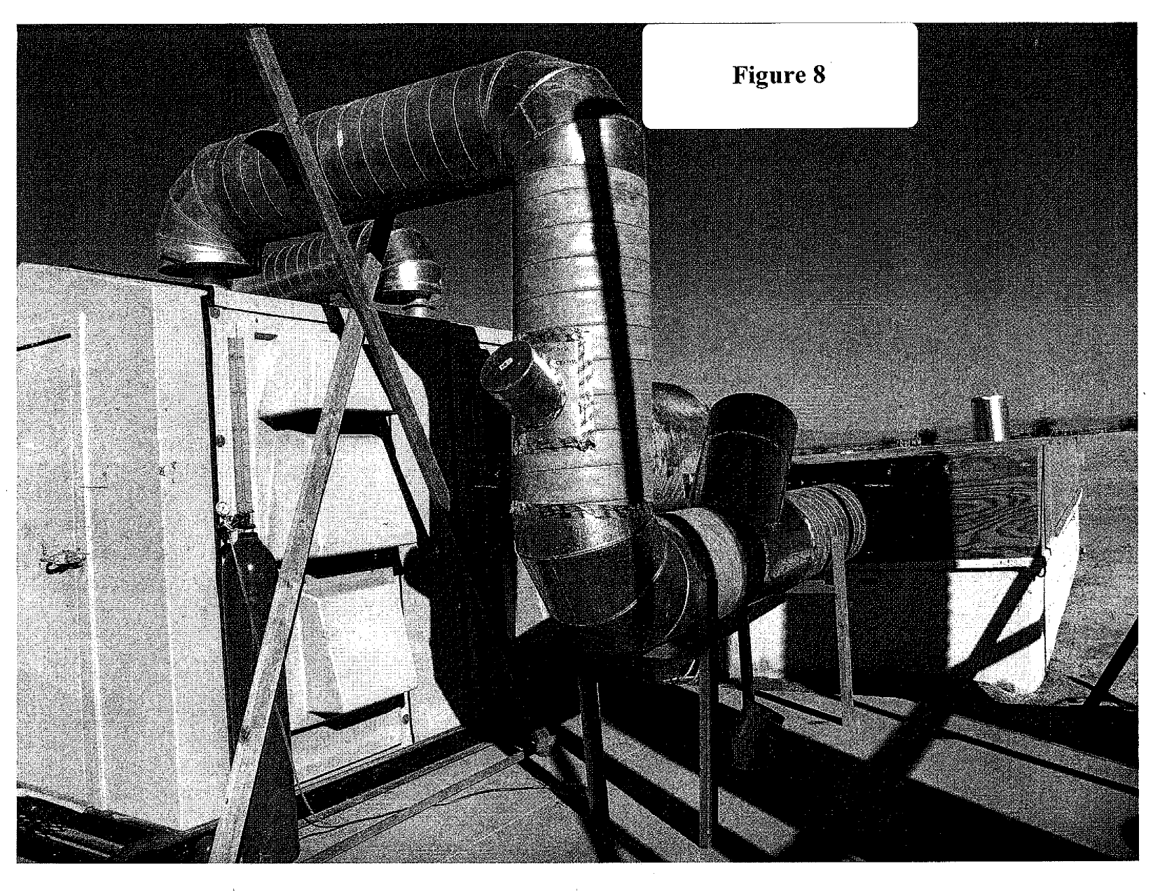

In an alternative embodiment of a column submerged in water for the removal of carbon dioxide from a stationary engine, depicted in FIG. 3. The column in FIG. 3 is submerged below the water level 6. The exhaust gas enters through inlet 1. As the exhaust bubbles pass through the variably spaced screens 3, the bubbles are progressively reduced in size 2. As the bubbles pass through the column, the negative pressure created in the column suck water through inlets 4 located on the sides of the column. As the exhaust bubbles pass through the column, the carbon dioxide is absorbed by the water. The purified gas exits the column through the top of the column 5. The column can be partially submerged, or wholly submerged to any suitable depth.

In some embodiments, water is introduced into the column, preferably at the top of the column so as to provide counter-current flow when exhaust gas is introduced into the column below the water inlet. Water that has taken up carbon dioxide from the exhaust gas stream is discharged from the column at the bottom. Desirably, the exhaust gas is exposed to increasingly fresh water as the gas rises to the top of the column; however, other configurations can also be employed. The water at the top of the column, having a higher pH, has greater effectiveness at capturing CO₂, which becomes less concentrated in the gas to be treated as it rises through the column. The water discharged from the column, now containing dissolved CO₂, is introduced to suspensions of algae that can utilize the captured CO₂.

In some embodiments, the columns are arranged horizontally where the water enters at one end of the column and exhaust enters through the other end. The water entering the horizontal column, having a higher pH, has greater effectiveness at capturing CO2, which becomes less concentrated in the gas to be treated as it progresses through the column. In some embodiments the water may enter at the same end of the column as the exhaust. In still other embodiments, the water may enter at some point along the length of the column and the exhaust enters through one end of the column. In further embodiments, the exhaust may enter at some point along the length of the column.

In some embodiments, the horizontally-arranged column is corrugated or contains folds to reduce the total volume containing the column.

The column depicted in FIG. 1 employs a series of screens along a portion of its length. The screens function to break up large bubbles from the engine exhaust source into smaller bubbles having a greater surface area. Because the bubbles will tend to coalesce as they rise through the column, a series of spaced-apart screens are provided so as to control bubble size as gas rises up through the column by reiteratively breaking up the bubbles as they rise and pass through successive screens. The screens also are effective in slowing the rise of the gas bubbles in the column, thereby increasing residence time in the column and maximizing time of contact of the gas bubbles with the liquid without increasing the distance that the bubbles must travel upward. Additionally, the screens create a surface tension boundary between the levels in the column that cause the bubbles to swirl in the chambers between screens, increasing contact time. Desirably, the column has a head pressure of at least about 6 feet; however, in certain embodiments a higher or lower head pressure can be advantageously employed.

The screens employed are preferably of a mesh size sufficiently small so as to provide an optimized bubble size without offering too much resistance to fluid flow through the column. Screens of 5 mesh to 20 mesh are typically employed, preferably about 10 mesh; however, in certain embodiments larger or smaller mesh sizes can also be employed. The number and spacing of the screens can be adjusted depending upon the average bubble size desired and the flow rate through the column. Preferred screen spacings are typically from about 6 inches or less to about 2 feet or more, preferably about 1 foot apart. Desirably, a series of screens is provided beginning above the exhaust gas inlet at the bottom of the column and extending up to under the water inlet at the top of the column.

The height of the column can be selected based, at least in part, upon the amount of carbon dioxide in the gas to be treated and the pH of the water, e.g., as generated by the algae. For removal of carbon dioxide from gases as described above, a column from about 6 feet to about 12 feet in length can be employed, preferably a column from about 7 feet to about 11 feet in length, more preferably about 8 or 9 to 10 feet in length. While shorter or taller columns can be employed in certain embodiments, it is generally preferred to adjust the flow rate of water through the column to accommodate different carbon dioxide concentrations and/or water pHs to optimize carbon dioxide removal. For example, slower flow rates can be desirable for higher carbon dioxide concentrations in the gas to be treated and/or less alkaline conditions (e.g., pH less than 9, but greater than about 7.5).

The diameter of the column can be selected based upon the volume of gas to be treated. One column having a larger diameter can be employed to treat a given volume of gas, or several columns of smaller diameters operating in parallel can be employed to treat the same volume. For a small stationary diesel engine (e.g., for generating up to about 2500 kW), a column having a diameter of from about 4 inches to about 12 inches can be employed, more preferably a column having a diameter of about 10 inches. While tubular column configurations are generally desirable for ease of construction from commercially available pipe, other configurations can also be employed (square or triangular configurations).

The exhaust gas exiting the column can be recycled through the column, directed to a second column for removal of additional carbon dioxide, or to another apparatus for removal of other contaminants or pollutants (e.g., nitrogen oxides, sulfur dioxide, carbon monoxide, hydrocarbons and particulate matter). Any desired number of columns and/or additional removal devices can be employed in serial configurations, parallel configurations, or combinations thereof.

Devices having other configurations can also be employed for carbon dioxide removal. Depicted in FIG. 3 is a device configured for immersion in a body of water. The column depicted employs a series of screens, and multiple water inlets situated along the column length. Rising exhaust gas bubbles entrain water adjacent to the column, and the exiting bubbles with a reduced carbon dioxide content are discharged to the environment. It is generally preferred to employ a shell or pipe as a column in an immersed system, so as to prevent dispersion of the bubbles or to prevent the bubbles bypassing the screens and coalescing. However, in certain embodiments it may be possible to minimize enclosure of the column, e.g., by providing perforations, slits, or passages in the column wall in addition to, or instead of, water inlets or ports, or to provide open spacers to hold apart a series of screens without constraining walls. In an immersed system, it may also be possible, depending upon the method of introducing the exhaust gas into the water, to minimize the number of screens or omit them altogether, while still achieving satisfactory reductions in carbon dioxide content.

### Paddle Wheels

In another preferred embodiment, a water reservoir is employed for purification of CO₂ exhaust. These water reservoirs can include tanks, pools, ponds, man-made lake or larger lake-like structures. In a preferred embodiment, these reservoirs contain paddle wheels or other devices capable of agitating the water, including stirring devices that facilitate dissolution of gases within the water by increasing the surface area of water exposed to the exhaust gas. In some embodiments, the paddle-wheels are partially submerged in the water. As they rotate, the water is used to solubilized the carbon dioxide in the exhaust gas. In some embodiments, the paddle wheel is powered by motor that facilitates spinning of the paddle wheel within the water to increase the surface area of water exposed to the gas.

Aside from paddle wheels, other agitating devices can be used. Some embodiments include surface splashers, water mixers, and aerators. In some embodiments, surface splashers are used. They comprise an electric motor on a vertical axis with an underlying marine type propeller. In some embodiments, the surface splasher is supported by a float. The propeller pushes the water upwards which then falls back down giving rise to a characteristic mushroom shape. This agitation gives rise to the solubilization of carbon dioxide. Other embodiments employ water mixers. They are composed of a propeller driven by an electric motor, the whole being moved by movable means of a hoist on vertical runners fixed to the tank walls or, at a fixed depth, to floating structures. Still other embodiments employ aerators consisting of a floating structure that bears a propeller driven by an electric motor or a combustion engine. The aerator, except for the propeller, emerges from the open surface of the mass transfer device. In some embodiments, the propeller can be oriented in the vertical plane, with the need of keeping the propeller submerged limiting the degree of orientation. These aerators permit good circulation, destratification, and aeration, to solubilize the carbon dioxide in the exhaust gas in the water.

In alternative embodiments, the reservoir can contain one or more paddle wheels or agitating devices, for example, 1, 2, 3, 4, 5, 6, 7, 8, 9, 10, 11, 12, 13, 14, 15, 16, 17, 18, 19, 20, 21, 22, 23, 24, 25, 26-30, 31-35, 36-40, 41-45, 46-50, 51-55, 56-60, 61-65, 66-70, 71-75, 76-80, 81-85, 86-90, 91-95, 96-100, or more paddle wheels or agitating devices.

In some embodiments, the reservoir contains aqueous algae suspensions. An exhaust stream containing carbon dioxide is subsequently introduced into the reservoir. The paddle wheels, or other agitating devices, facilitate the dissolution of carbon dioxide into the aqueous suspension by increasing the surface area of the water exposed to the exhaust stream. In some embodiments, fresh water is added to the reservoir to keep the pH of the water at a high enough level to facilitate the efficient dissolution of CO₂ therein.

In some embodiments, the reservoir is covered to prevent the escape of gases. Alternative embodiments of the covers include tarp, wood, plastic, glass, PLEXIGLAS®, metal covers, or any other materials that are capable of preventing the escape of gasses from the reservoir into the atmosphere.

The exhaust gas exiting the reservoir can be recycled through the reservoir, directed to a subsequent reservoir for removal of additional carbon dioxide, directed to another apparatus for removal of other contaminants or pollutants (e.g., nitrogen oxides, sulfur dioxide, carbon monoxide, hydrocarbons and particulate matter), or expelled into the atmosphere. Any desired number of reservoirs and/or additional removal devices can be employed in serial configurations, parallel configurations, or combinations thereof.

In other embodiments, the reservoir contains water ready to uptake carbon dioxide. An exhaust stream containing carbon dioxide is subsequently introduced into the reservoir. The paddle wheels, or other agitating devices, facilitate the dissolution of carbon dioxide into the water by increasing the surface area of the water exposed to the exhaust stream. In some embodiments, fresh water is added to the reservoir to keep the pH of the water at a high enough level to facilitate the efficient dissolution of CO₂ therein.

In some embodiments, the reservoir is covered to prevent the escape of gases. Alternative embodiments of the covers include tarp, wood, plastic, glass, PLEXIGLAS®, metal covers, or any other materials that are capable of preventing the escape of gasses from the reservoir into the atmosphere.

The exhaust gas exiting the reservoir can be recycled through the reservoir, directed to a subsequent reservoir for removal of additional carbon dioxide, directed to another apparatus for removal of other contaminants or pollutants (e.g., nitrogen oxides, sulfur dioxide, carbon monoxide, hydrocarbons and particulate matter), or expelled into the atmosphere. Any desired number of reservoirs and/or additional removal devices can be employed in serial configurations, parallel configurations, or combinations thereof. After the dissolution of the CO₂ in the water, the carbon dioxide containing water is removed from the reservoir and introduced to algae suspensions that can utilize the captured CO₂. In some embodiments, after the carbon dioxide within the water is depleted by the algae suspension, the water is returned to reservoirs to again capture carbon dioxide from exhaust. In alternative embodiments, the carbon dioxide depleted water is expelled as waste water.

The exhaust gas can be introduced by any suitable method. A pipe operating at relatively low pressure, e.g., less than 5 psi, can be employed. Systems for providing aeration at the bottom of water treatment tanks are also suitable for use, e.g., perforated pipes, spargers, diffusers, and the like.

The systems of preferred embodiments, when employed to treat a gas containing about 15% by volume of carbon dioxide, can reduce carbon dioxide by a significant amount (e.g., to less than 500 ppm). The system provides economical carbon dioxide removal even when mixed with a large percentage of inert gas that would otherwise interfere with its absorption. The systems of preferred embodiments may also be effective in removing other components from the gas, e.g., particulates.

### Algae

The methods of preferred embodiments employ water containing algae. Any suitable species of algae can be employed; however, it is generally desirable to employ algae indigenous to water sources adjacent to the source of gas to be treated. Such water sources can include natural bodies of water, e.g., a pond containing stagnant water, or water containing cultured algae. The algae can be natural algae, cultured algae, genetically modified algae, of a single species, of multiple species, or combinations thereof. As discussed above, it is generally preferred that the gas to be treated be minimally toxic to the algae, such as typical diesel engine exhaust gases, boiler gases, and other gases generated by combustion of hydrocarbons. However, gas that is toxic to algae can also be treated, if the algae are capable of removing some portion of the carbon dioxide contained in the gas before its activity is substantially impaired by the toxin, and if the water containing spent algae is replaced at a sufficient rate by fresh water with active algae.

In one preferred embodiment, the green-blue algae Spirulina is used. Spirulina is a photosynthetic, filamentous, spiral-shaped, multicellular and green-blue microalga. Since this organism contains chlorophyll a, like higher plants, botanists classify it as a microalga belonging to Chyanophyceae class; but according to bacteriologists it is a bacterium due to its prokaryotic structure. Its chemical composition includes proteins (55%-70%), carbohydrates (15%-25%), essential fatty acids (18%) vitamins, minerals and pigments like carotenes, chlorophyll a and phycocyanin and lends itself to use as a food supplement. Spirulina are “extremophiles,” growing better than other algae in highly alkaline waters.

In certain embodiments, algae are selected for their efficiency as potential biodiesel feedstocks. Microalgae contain lipids and fatty acids as membrane components, storage products, metabolites and sources of energy. Algal strains, diatoms, and cyanobacteria (categorized collectively as “Microalgae”) have been found to contain proportionally high levels of lipids (over 30%). In some embodiments, these microalgal strains with high oil, or lipid content can be used due to their ability to produce sustainable feedstock for the production of biodiesel.

Lipid accumulation in algae typically occurs during periods of environmental stress, including growth under nutrient-deficient conditions. Biochemical studies have suggested that acetyl-CoA carboxylase (ACCase), a biotin-containing enzyme that catalyzes an early step in fatty acid biosynthesis, may be involved in the control of this lipid accumulation process. Therefore, it may be possible to enhance lipid production rates by increasing the activity of this enzyme via genetic engineering.

In some embodiments, the following species of algae can be used for their high lipid oil content: Neochloris oleoabundans, a microalga belonging in the class Chlorophyceae; Scenedesmus dimorphus, is a unicellular algae in the class Chlorophyceae; Euglena gracilis; Phaeodactylum tricornutum, a diatom; Pleurochrysis carterae, a unicellular coccolithophorid alga that has the ability to calcify subcellularly and a member of the class Haptophyta (Prymnesiophyceae); Prymnesium parvum; Tetraselmis chui, a marine unicellular alga; Tetraselmis suecica Isochrysis galbana, a microalga; Nannochloropsis salina, also called Nannochloris oculata; Nannochloris atomus Butcher; Nannochloris maculata Butcher; Nannochloropsis gaditana Lubian; and Nannochloropsis oculata (Droop); Botryococcus braunii; Nannochloris sp.; Chlorophyceae (green algae).

In certain embodiments, water from the column after carbon dioxide removal is merely discharged as waste. However, the water containing algae enriched by the carbon dioxide removed from the exhaust gas can desirably be employed in other applications. For example, the water may be desirable for irrigating crops. Alternatively, the algae can be removed from the water and used, e.g., as fertilizer, animal feed, a source of chlorophyll or other chemicals, or as a biomass for the production of biofuels (e.g., ethanol, biodiesel, and the like).

### Experimental

A system, depicted in FIGS. 2a and 2b, was constructed for removing nearly all of the CO₂ from the exhaust gas generated by a stationary diesel engine. The column was constructed using PVC pipe and screen. Each pipe section had a 3 inch diameter and was 12 inches long. Screen was glued to the bottom of each pipe section, and the sections were connected with standard pipe connectors. The screen was a commercially available plastic window screen with square holes that were about 1/10 of an inch on each side. The pipe sections were assembled into a single column with a gas inlet near the bottom, a water inlet on top of the column, and a water outlet on the very bottom of the column. The entire exhaust gas output of the diesel engine was introduced into the column.

The column was filled with pond water containing algae indigenous to the Imperial Valley of California, giving the water a high pH as a result of algae respiration. The water, at ambient temperature (approximately 20° C.), was pumped into the top of the column. Exhaust gas from a small diesel engine was piped into the exhaust intake port of the column after being cooled through a radiator. During the process, water flowed downward through the column and was drained out of the bottom of the apparatus. Valves controlled the water and gas flowing through the system. The column employed a water trap at the bottom to inhibit gases from exiting the bottom of the column

The pH of the water put into the top of the column versus the pH of the water exiting the bottom of the column was significantly higher, indicating the water was absorbing acidic species from the gas so as to lower the pH. The water entering the column was about pH 9.5 and the water exiting the column was about 6.5. The carbon dioxide concentration of the exhaust coming out of the top of the column was negligible (less than 500 ppm, the detection limit of the CO₂ meter). By turning water flowing through the column off, the concentration of carbon dioxide rose quickly to a value exceeding the upper limit measurable by the CO₂ meter.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A method for removing carbon dioxide from a gas, the method comprising:
providing a reservoir equipped with at least one paddle wheel, the reservoir containing water containing algae indigenous to the Imperial Valley of California;
introducing a gas containing about 15% by volume or less of carbon dioxide into the water, whereby at least a portion of the carbon dioxide is solubilized in the water through the action of the paddle wheel, and wherein the solubilized carbon dioxide is metabolized by the algae; and
removing a treated gas from the reservoir, wherein a concentration of carbon dioxide in the treated gas is less than 500 ppm.

2. The method of claim 1, wherein the reservoir is selected from the group consisting of a tank, a pool, a pond, and a manmade lake.

3. The method of claim 1, wherein the algae is Spirulina.

4. The method of claim 1, wherein the treated gas is introduced into an additional reservoir for removing additional carbon dioxide from the treated gas.

5. The method of claim 1, wherein algae respiration increases a pH of the water to a value of about 9 or greater.

6. The method of claim 1, wherein algae respiration increases the pH of the body of water to a value from about 9 to about 9.5.

7. The method of claim 1, wherein the gas containing about 15% by volume or less of carbon dioxide is exhaust gas from an engine that burns hydrocarbon fuel.

8. The method of claim 7, wherein the engine is a diesel engine.

9. The method of claim 1, further comprising a step of processing the algae after it has metabolized the carbon dioxide from the gas to obtain at least one of an oil and a lipid for use in the production of biodiesel.

10. The method of claim 1, further comprising a step of irrigating a crop with the water containing the algae after it has metabolized the carbon dioxide from the gas.

11. The method of claim 1, wherein the water is at a temperature of approximately 20° C.

12. A mass transfer device for removing carbon dioxide from a gas, the device comprising:
a reservoir configured to contain water containing an algae indigenous to the Imperial Valley of California, wherein the algae metabolizes carbon dioxide;
a first inlet configured to introduce water into the reservoir;
a second inlet configured to introduce a gas containing about 15% by volume or less carbon dioxide into the reservoir;
at least one agitating device situated within the reservoir and configured to agitate the carbon-dioxide absorbing liquid, wherein the agitating device is a paddle wheel;
a motor configured to provide power to the agitating device;
an outlet configured to release treated gas from the reservoir; and
an outlet for water containing a suspension of algae having metabolized carbon dioxide.
